(19) United States
(12) Patent Application Publication
(10) Pub. No.: US 2026/0031506 A1
(43) Pub. Date: Jan. 29, 2026

(54) ALL-SOLID-STATE BATTERY

(71) Applicant: Maxell, LTD., Otokuni-gun, Kyoto (JP)

(72) Inventors: Seiji Sato, Otokuni-gun (JP); Koji Yamaguchi, Otokuni-gun (JP); Kazuki Furukawa, Otokuni-gun (JP); Takumi Otsuka, Otokuni-gun (JP); Shumpei Masuda, Otokuni-gun (JP); Takeshi Saito, Otokuni-gun (JP)

(73) Assignee: Maxell, LTD., Otokuni-gun, Kyoto (JP)

(21) Appl. No.: 19/099,974

(22) PCT Filed: Jul. 28, 2023
(86) PCT No.: PCT/JP2023/027790

§ 371 Date: Jan. 30, 2025

(30) Foreign Application Priority Data
Aug. 2, 2022 (JP) 2022-123365

(51) Int. Cl. H01M 50/536; H01M 10/0585; H01M 50/109; H01M 50/533

(52) U.S. Cl. CPC H01M 50/536; H01M 10/0585; H01M 50/109; H01M 50/533

(57) ABSTRACT

The all-solid-state battery includes: a case including a recessed container and a cap covering the opening of the recessed container; a power generation element contained in the case and including an electrode layer, an electrode layer and a solid electrolyte layer stacked upon one another; and an elastic conductive member located between the power generation element and the inner bottom surface of the recessed container. The elastic conductive member, together with the power generation element, is pushed into the recessed container to be contained therein. The electrode layer includes an electrode mixture layer and a porous metal layer. The elastic conductive member contacts the porous metal layer and, by means of its elastic force, presses the power generation element toward the cap. The all-solid-state battery of the present invention is relevant to Goals and of the SDGs.

### TECHNICAL FIELD

The present disclosure relates to an all-solid-state battery with a power generation element sealed in a case.

### BACKGROUND ART

In recent years, with the development of portable electronic devices such as cellular phones and notebook personal computers and the commercialization of electric vehicles, for example, demand has been increasing for secondary batteries that are compact and light-weight and yet have high capacity and high energy density. Currently, nonaqueous secondary batteries, particularly lithium-ion secondary batteries that can meet these demands include: a cathode active material constituted by a lithium containing composite oxide such as lithium cobalt oxide (LiCoO₂) or lithium nickel oxide (LiNiO₂): an anode active material constituted by graphite, for example; and a nonaqueous electrolyte constituted by an organic electrolyte containing an organic solvent and a lithium salt. With the development of equipment using such nonaqueous secondary batteries, nonaqueous secondary batteries are expected to provide even longer service life, higher capacity and higher energy density and, at the same time, required to have high reliability.

However, an organic electrolyte contains organic solvents, which are flammable substances. As such, when an abnormal event such as a short circuit occurs in the battery, abnormal heating may occur in the organic electrolyte. In recent years, nonaqueous secondary batteries have become more energy-dense, and there has been a tendency for the amounts of organic solvents in the organic electrolyte to increase, in view of this, even higher reliability has been expected for nonaqueous secondary batteries.

These circumstances have led to research on all-solid-state secondary batteries that use no organic solvents. Instead of conventional organic solvent-based electrolytes, all-solid-state secondary batteries use a power generation element (i.e., electrode laminate) including a molding of a solid electrolyte with no organic solvents and moldings of electrode mixtures for the positive and negative electrodes, stacked upon one another. Thus, all-solid-state secondary batteries, which have a solid electrolyte with no risk of abnormal heating, have high reliability.

In connection with such all-solid-state secondary batteries, various methods have been proposed to provide sufficient current-collecting performance between the power generation element, on the one hand, and a conductor provided in the case that houses the power generation element, on the other.

Patent Document 1 (WO 2012/141231 A1) discloses a solid-state battery. The solid-state battery includes: a battery element including a positive electrode layer, a solid electrolyte layer and a negative electrode layer; a container member that houses the battery element and includes conductor parts; and a positive electrode terminal and a negative electrode terminal disposed on the outer surface of the container member. The solid-state battery further includes a collector member positioned between at least one of the positive electrode layer or negative electrode layer and the container member to be connected to the conductor parts of the container member, the collector member being elastic and containing a conductive substance. The collector member may contain, for example, at least one of a carbon material or an electrically conductive rubber, and may also include either a carbon sheet or an anisotropically conductive rubber sheet. This allows the solid-state battery to maintain a good electrical connection to the electrode layers of the battery element.

Patent Document 2 (JP 2010-165681 A) discloses a galvanic element. The galvanic element includes a cathode, an anode, an electrolyte, a separator positioned between the cathode and anode, and a housing. The galvanic element, although not an all-solid-state battery, includes at least one electrically conductive spring element. The conductive spring element presses, via a conductive intermediate element, the cathode or anode toward the separator. The conductive spring element increases the reliability of the electrical connection between the electro-active material in the cathode or anode, on the one hand, and the housing, on the other.

### PRIOR ART DOCUMENTS

### Patent Documents

Patent Document 1: WO 2012/141231 A1
Patent Document 2: JP 2010-165681 A

### SUMMARY OF THE INVENTION

As discussed above, the collector member of Patent Document 1 and the conductive spring element of Patent Document 2 increase reliability in terms of electrical connection. However, in response to the recent demand for second batteries that are compact and light-weight while offering high capacity and high energy density, it is essential to further enhance the reliability of electrical connection in all-solid-batteries.

In response to the above issue, it is an object of the present disclosure to provide an all-solid-state battery with a current-collecting structure that has high reliability in electrical connection.

In response to the above issue, the present disclosure provides the following arrangement: An all-solid-state battery according to the present disclosure may include a case including a recessed container having a bottom and a side wall and a cap covering an opening of the recessed container, a power generation element sealed in the case and including a first electrode layer located adjacent to the bottom, a second electrode layer located adjacent to the cap and a solid electrolyte layer located between the first electrode layer and the second electrode layer, and an elastic conductive member located between the power generation element and an inner bottom surface of the bottom of the recessed container. The first electrode layer may include a first electrode mixture layer and a first porous metal layer located between the first electrode mixture layer and the elastic conductive member, and may be electrically connected to a first conductive path running from an interior of the case to an outside of the case via the elastic conductive member. The second electrode layer may include a second electrode mixture layer and a second porous metal layer located between the second electrode mixture layer and the cap, and may be electrically connected to a second conductive path running from the interior of the case to the outside of the case. The first porous metal layer may be at least partially embedded in a surface layer of the first electrode mixture layer and integrated with the first electrode mixture layer. A side of the first porous metal layer opposite to a side adjacent to the first electrode mixture layer may be exposed at a surface of the first electrode layer. The second porous electrode layer may be at least partially embedded in a surface layer of the second electrode mixture layer and integrated with the second electrode mixture layer. A side of the second porous metal layer opposite to a side adjacent to the second electrode mixture layer may be exposed at a surface of the second electrode layer. The elastic conductive member may be adapted to contact the first porous metal layer to press the power generation element toward the cap.

An all-solid-state battery according to the present disclosure has a current-collecting structure with improved reliability in electrical connection.

### BRIEF DESCRIPTION OF DRAWINGS

FIG. 1 is a cross-sectional view of an all-solid-state battery according to a first embodiment of the present disclosure.

FIG. 2 is a perspective view of a recessed container for the all-solid-state battery of FIG. 1.

FIG. 3 is a plan view of the all-solid-state battery of FIG. 1 (with the cap and conductive plate removed).

FIG. 4 is a plan view of the all-solid-state battery of FIG. 1 (with the cap, conductive plate and power generation element removed).

FIG. 5 is a cross-sectional view illustrating how the power generation element and elastic conductive member can be placed inside the recessed container.

FIG. 6 is a perspective view of the conductive plate shown in FIG. 1.

FIG. 7 is a cross-sectional view of an all-solid-state battery including an elastic conductive member of Variation 1.

FIG. 8 is a perspective view of the elastic conductive member shown in FIG. 7.

FIG. 9 is a perspective view of an elastic conductive member of Variation 2.

FIG. 10 is a perspective view of an elastic conductive member of Variation 3.

FIG. 11 is a cross-sectional view of an all-solid-state battery according to a second embodiment.

FIG. 12 is a graph illustrating how to calculate load rate.

### EMBODIMENTS FOR CARRYING OUT THE INVENTION

The present inventors did extensive research and discovered that, rather than having a conductive elastic member, for example, directly contact the surface of a molding of an electrode mixture containing an active material, positioning a porous metal substrate on the surface of a molding of an electrode mixture and having this substrate contact a conductive elastic member or the like will sufficiently reduce internal resistance and also provide sufficient absorption of variations in the thickness of the power generation element or the height of the case, for example, thereby reducing variations in internal resistance value. The present disclosure was made based on these discoveries.

### Arrangement 1

An all-solid-state battery according to an embodiment of the present disclosure may include: a case including a recessed container having a bottom and a side wall and a cap covering an opening of the recessed container; a power generation element sealed in the case and including a first electrode layer located adjacent to the bottom, a second electrode layer located adjacent to the cap and a solid electrolyte layer located between the first electrode layer and the second electrode layer; and an elastic conductive member located between the power generation element and an inner bottom surface of the bottom of the recessed container. The first electrode layer may include a first electrode mixture layer and a first porous metal layer located between the first electrode mixture layer and the elastic conductive member, and may be electrically connected to a first conductive path running from an interior of the case to an outside of the case via the elastic conductive member. The second electrode layer may include a second electrode mixture layer and a second porous metal layer located between the second electrode mixture layer and the cap, and may be electrically connected to a second conductive path running from the interior of the case to the outside of the case. The first porous metal layer may be at least partially embedded in a surface layer of the first electrode mixture layer and integrated with the first electrode mixture layer. A side of the first porous metal layer opposite to a side adjacent to the first electrode mixture layer may be exposed at a surface of the first electrode layer. The second porous electrode layer may be at least partially embedded in a surface layer of the second electrode mixture layer and integrated with the second electrode mixture layer. A side of the second porous metal layer opposite to a side adjacent to the second electrode mixture layer may be exposed at a surface of the second electrode layer. The elastic conductive member may be adapted to contact the first porous metal layer to press the power generation element toward the cap.

Thus, the all-solid-state battery 1 will be able to sufficiently reduce internal resistance and, in addition, sufficiently absorb variations in the thickness of the power generation element or the height of the case, for example, thereby reducing variations in internal resistance value. As a result, reliability in electrical connection in the all-solid-state battery will be increased.

### Arrangement 2

Starting from the all-solid-state battery of Arrangement 1, the elastic conductive member may be a metal spring. This will provide an electrical connection with a lower internal resistance than in arrangements where the elastic conductive member used is a conductive rubber or carbon sheet, for example.

### Arrangement 3

Starting from the all-solid-state battery of Arrangement 1, the elastic conductive member may include a flat surface adapted to contact the first porous metal layer and a leg extending toward the inner bottom surface of the bottom of the recessed container. Thus, the elastic force of the elastic conductive member can be used to appropriately press the power generation element toward the cap and, in addition, its contact area with the first electrode layer will be increased, thereby maintaining a good electrical connection.

### Arrangement 4

Starting from the all-solid-state battery of Arrangement 1, the elastic conductive member may be a disk spring. This will enable sufficiently pressing the power generation element toward the cap even if the volume of the internal space of the case 10 that is occupied by the elastic conductive member is reduced.

### Arrangement 5

Starting from the all-solid state battery of Arrangement 1, the elastic conductive member may be a waved washer. Thus, the power generation element or the inner bottom surface of the bottom of the recessed container will be in surface contact with the waved washer at a plurality of locations, thereby maintaining a good electrical connection. Further, a waved washer has no sharp ends as formed by a part broken off somewhere through it. thereby reducing the risk of damaging the power generation element.

### Arrangement 6

Starting from the all-solid-state battery of Arrangement 1, the elastic conductive member may be a conical spring. Thus, the power generation element or the inner bottom surface of the bottom of the recessed container will be in annular contact with the conical spring, thereby enabling sufficiently pressing the power generation element toward the cap even if the volume of the internal space of the case 10 that is occupied by the elastic conductive member is further reduced, thus maintaining a good electrical connection.

### Arrangement 7

Starting from the all-solid-state battery of any one of Arrangements 1 to 6, the all-solid state battery may further include a conductive plate between the power generation element and the cap. The conductive plate may be adapted to restrain movement, toward the cap, of the power generation element as pressed by the elastic conductive member. The second electrode layer may be electrically connected to the second conductive path via the conductive plate. The all-solid-state battery further may comprise a clearance between the conductive plate and the cap. This will prevent the cap from deforming due to the pressing by the elastic conductive member or a load from being applied to joints between the recessed container and cap. Further, since there is no electrical conduction between the cap and power generation element, the cap will not have a potential.

### Arrangement 8

An all-solid-state battery according to another embodiment of the present disclosure includes: a case including a recessed container having a bottom and a side wall and a cap covering an opening of the recessed container; a power generation element sealed in the case and including a first electrode layer located adjacent to the bottom, a second electrode layer located adjacent to the cap and a solid electrolyte layer located between the first electrode layer and the second electrode layer; an elastic conductive member located between the power generation element and an inner bottom surface of the bottom of the recessed container; and a conductive plate located between the power generation element and the cap. The first electrode layer is electrically connected to a first conductive path running from an interior of the case to an outside of the case via the elastic conductive member. The second electrode layer is electrically connected to a second conductive path running from the interior of the case to the outside of the case via the conductive plate. The elastic conductive member is adapted to contact the first electrode layer to press the power generation element toward the cap. The conductive plate is adapted to contact the second electrode layer to restrain movement of the power generation element toward the cap. A load rate of the conductive plate is higher than a load rate of the elastic conductive member.

As the load rate of the conductive plate is higher than the load rate of the elastic conductive member, a clearance will be formed between the conductive plate and cap. This will prevent the cap from deforming due to the pressing by the elastic conductive member or a load from being applied to joints between the recessed container and cap. Further, since there is no electrical conduction between the cap and power generation element, the cap will not have a potential.

### First Embodiment

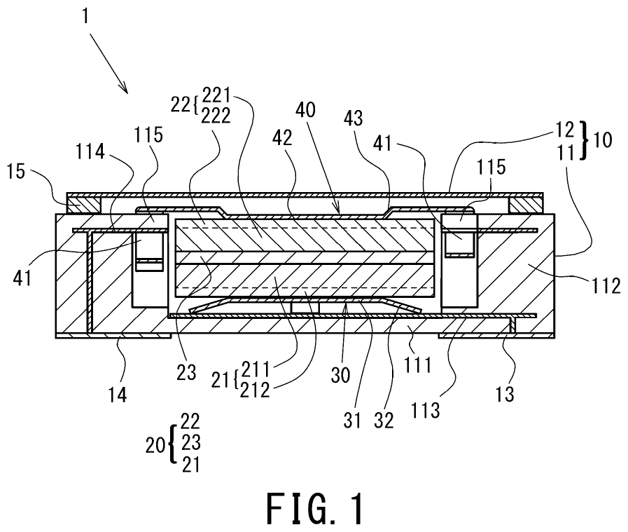

Now, a first embodiment of the present disclosure will be specifically described with reference to FIGS. 1 to 6. First, as shown in FIG. 1, an all-solid-state battery 1 includes a case 10, a power generation element 20 contained in the case 10, an elastic conductive member 30 and a conductive plate 40, and an external terminal 13 and an external terminal 14 located on the outer surface of the case 10.

The case 10 includes a recessed container 11 and a cap 12. The recessed container 11 is made of ceramics. The recessed container 11 includes a rectangular bottom 111 and a side wall 112 having the shape of a rectangular tube with a columnar space for housing the power generation element 20, the outer periphery of the bottom 111 and the side wall being continuously formed. As seen in longitudinal cross-sectional view, the side wall 112 extends generally perpendicular to the bottom 111. A conductor 113 is provided inside the bottom 111. The conductor 113 is provided between the power generation element 20 and bottom 111 to extend along them for conductive connection with the power generation element 20, thereby providing a conductive path for the electrode layer 21. A conductor 114 is provided within the side wall 112. As shown in FIG. 1, some portions of the conductor 114 are exposed at the inner peripheral surface of the side wall 112, at the lower surfaces and side surfaces of supports 115, discussed further below, thereby providing a conductive path for the electrode layer 22. A method of manufacturing the recessed container 11 will be described further below. The recessed container 11 is not limited to any particular material, and examples include resin, glass (e.g., borosilicate glass and glass ceramics), metal, ceramics, and various other materials. A composite material with ceramic and/or glass powder dispersed in a resin may also be used. If the recessed container 11 is formed from a metal material, to ensure that the power generation element 20 is insulated from the recessed container 11, the inner surface of the bottom 111 of the recessed container 11 and the inner peripheral surface of the side wall 112 may be coated with an insulator, such as a resin material or glass. As seen in plan view, the recessed container 11 is not limited to a rectangular shape, and may be circular, elliptic, or polygonal. An interior space for housing the power generation element 20, is not limited to a cylindrical shape, and may be formed in a polygonal tube, such as a quadrangular tube, depending on the shape of the power generation element 20. Alternatively, the conductor 114 may be located on the inner surface of the side wall 112, rather than within the side wall 112, and may further extend through within the bottom 111 to be in conduction with the external terminal 14. In such implementations, to prevent the outer peripheral surface of the power generation element 20 and the conductor 114 from contacting each other, an insulating layer may be provided between the outer peripheral surface of the power generation element 20 and the conductor 114, such as on the inner surface of the conductor 114.

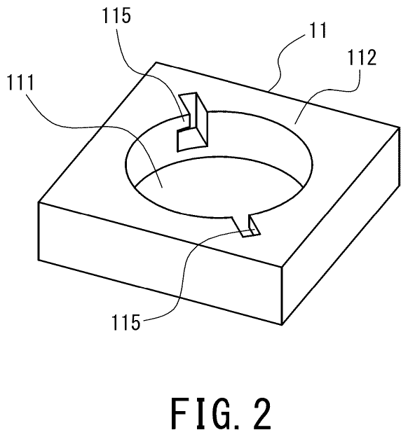

The side wall 112 includes a plurality of supports 115 that support the conductive plate 40, described further below. According to the present embodiment, the supports 115 are lugs located at the upper end of the inner peripheral surface of the side wall 112 and extending in a circumferential direction of the inner peripheral surface. More specifically, as shown in FIG. 2, the supports 116 are ceilings for a plurality of indentations formed in the inner peripheral surface of the side wall 112 and extending radially outward. Thus, the supports 115 extend in a circumferential direction of the inner peripheral surface. The lower surface of each support 115, that is, the lower surface of each ceiling, is capable of locking and supporting a supported portion 41, discussed further below, on the conductive plate 40. Further, although four supports 115 are provided in the present embodiment, supports are not limited to any number; for example, if two supported portions 41 are provided on the conductive plate 40, two supports 115 may be provided at locations corresponding to the supported portions 41.

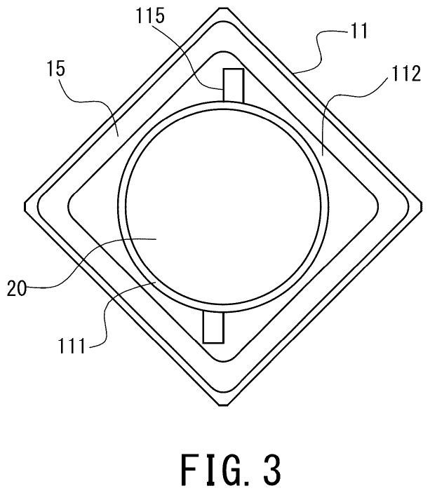

The cap 12 is a rectangular, thin metallic plate covering the opening of the recessed container 11. As shown in FIGS. 1 and 3, the cap 12 is joined (i.e., seam-welded) to the recessed container 11 by a seal ring 15 having the shape of a rectangular frame and positioned between the lower surface of the outer peripheral edge of the cap and the upper end of the recessed container 11. Thus, the interior space of the case 10 is completely hermetic. In view of effects on the power generation element 10, the interior space of the case 10 is preferably a vacuum atmosphere or inert gas atmosphere, such as nitrogen. The cap 12 is not limited to a metallic thin plate, and can cover the opening of the recessed container 11. The cap 12 is not limited to a rectangular shape and may be varied depending on the shape of the recessed container 11 as seen in plan view, and may be circular, elliptical or polygonal, for example. Further, the cap 12 may include other shapes than a flat plate. In some implementations, the cap 12 may be bonded to the recessed container 11 with an adhesive, and the joining of the cap 12 to the recessed container 11 is not limited to any particular method; any joining method may be used that can hermetically seal the interior space of the case 10.

The external terminal 13 is located on the outer surface of the bottom 111 of the recessed container 11. The external terminal 13 is electrically connected to the elastic conductive member 30, discussed further below, via the conductor 113. The elastic conductive member 30 is electrically connected to the electrode layer 21, which functions as a cathode layer, as discussed below. Thus, the conductor 113 provides a conductive path that provides conduction between the external terminal 13 and cathode layer and the elastic conductive member 30 provides a connection terminal that provides conduction between that conductive path and electrode layer 21, and thus the external terminal 13 functions as a cathode terminal.

The external terminal 14 is located on the outer surface of the bottom 111 of the recessed container 11, separated from the external terminal 13. The external terminal 14 is electrically connected to the supported portions 41 of the conductive plate 40, discussed further below, via the conductor 114. As discussed further below, the conductive plate 40 is electrically connected to the electrode layer 22 which functions as an anode layer. Thus, the conductor 114 provides a conductive path that provides conduction between the external terminal 14 and anode layer, and the conductive plate 40 provides a connection terminal that provides conduction between this conductive path and electrode layer 22, and thus the external terminal 14 functions as an anode terminal. The external terminals 13 and 14 are not limited to the above-described positioning, and may be positioned on the outer surface of the side wall 112 of the recessed container 11; alternatively, the cap 12 may function as the conductor 114 and the external terminal 14 may be provided on the outer surface of the cap 12. Positioning these two terminals on the outer surface of the bottom 111 of the recessed container 11 so as to be separated by a predetermined distance facilitates mounting on the surface of the circuit board.

A method of manufacturing the recessed container 11 will be described below. First, a metal paste is applied to a ceramic greensheet through printing to form a printed pattern that is to provide the conductors 113 and 114. Next, a plurality of such greensheets with printed patterns are laminated and baked. Laminating a plurality of greensheets with different shapes results in the above-described supports 115. In this way, a recessed container 11 is fabricated that contains conductors 113 and 114 and includes such supports 115 as described above on the inner peripheral surface of the side wall 112. The manufacturing is not limited to this method, and any method may be used that can form supports 116 on the inner peripheral surface of the side wall 112. The external terminals 13 and 14 may be formed by this printed pattern of metal paste.

The power generation element 20 includes an electrode laminate including an electrode layer (cathode layer) 21, an electrode layer (anode layer) 22 and a solid electrolyte layer 23 laminated together. The solid electrolyte layer 23 is positioned between the electrode layers 21 and 22. The power generation element 20 is columnar in shape. The power generation element 20 is laminated in such a manner that, from adjacent to the bottom 111 of the recessed container 11 (i.e., from the bottom in the drawing), the electrode layer 21, the solid electrolyte layer 23, and the electrode layer 22 are stacked in this order. In other words, the power generation element 20 is positioned such that one end thereof, i.e., the electrode layer 21, is located adjacent to the bottom 111 of the recessed container 11 and the other end, i.e., the electrode layer 22, is located adjacent to the cap 12, and the element is housed in the interior space of the case 10. The power generation element 20 is not limited to a columnar shape, and may be varied to include the shape of a rectangular parallelepiped or a prism, for example. Further, the power generation element 20 may include a plurality of laminates. The plurality of laminates may be stacked upon one another so as to be connected in series, and the all-solid-state battery 1 may be a bipolar cell.

The electrode layer 21 includes an electrode mixture layer (i.e., cathode mixture layer) 211 and a porous metal layer 212. The electrode mixture layer 211 is made of a cathode mixture containing a cathode active material constituted by lithium cobalt oxide, a sulfide-based solid electrolyte, and a conductive aid constituted by graphene in the ratio of 65:30:5 by mass. The porous metal layer 212 is formed by a sheet shaped porous metal substrate. The electrode layer 21 is a cathode pellet obtained by forming the electrode mixture layer 211 and porous metal layer 212 into a columnar shape so as to be stacked upon each other. At this moment, the electrode layer 21 is formed in such a manner that part of the porous metal layer 212 is embedded in the electrode mixture layer 211, more specifically in the surface layer of the electrode mixture layer 211 as shown in FIG. 1 (i.e., the surface layer that faces the porous metal layer 212). Thus, the porous metal layer 212 is formed in such a manner that the active material and/or conductive aid constituting the electrode mixture layer 211 and part of the porous metal substrate have more contact points and, as a result, reduces the internal resistance of the all-solid-state battery 1. Further, to reduce the resistance of the electrode layer 21 present when it contacts the elastic conductive member 30, the surface of the porous metal substrate may be exposed at the side of the porous metal layer 212 opposite to that adjacent to the electrode mixture layer 211. As shown in FIG. 1, the electrode mixture layer 211 is positioned to face the solid electrolyte layer 23. The porous metal layer 212 is located adjacent to the inner bottom surface of the bottom 111 of the recessed container 11, and in contact with the flat surface 31 of the elastic conductive member 30. As the porous metal layer 212 is positioned between the electrode mixture layer 211 and elastic conductive member 30, when the power generation element 20 is pressed by the elastic conductive member 30 toward the cap 12 as discussed further below, the contact resistance will be lower than in arrangements where the surface of the electrode mixture layer 211 directly contacts the flat surface 31 of the elastic conductive member 30, thus reducing the internal resistance of the all-solid-state battery 1. Thus, the all-solid-state battery 1 will be able to sufficiently reduce internal resistance and, in addition, sufficiently absorb variations in the thickness of the power generation element 20 or the height of the case 10, for example, thereby reducing variations in internal resistance value. As a result, reliability in electrical connection in the all-solid-state battery 1 will be increased. It will be understood that the cathode active material of the electrode mixture layer 211 is not limited to any particular type and is able to function as the cathode layer of the power generation element 20, and may be lithium nickel oxide, lithium manganese oxide, lithium-nickel-cobalt-manganese complex oxide, or olivine-type complex oxide, for example, or may be a predetermined mixture thereof. The other constituent materials and their proportions are not limited to any particular materials/proportions, either. The size and shape of the electrode layer 21 are not limited to a columnar shape, and may be varied depending on the size and shape of the all-solid-state battery 1.

More specifically, the porous metal layer 212 is preferably a porous body of a foamed metal with high porosity and having empty holes extending therethrough from one side to the other. To ensure that the empty holes in the porous metal layer 212 can easily be filled with electrode mixture during the step of pressurizing the porous metal layer 212 and electrode mixture layer 211 to facilitate integration of the porous metal layer 212 and electrode mixture layer 211, the porosity of the porous metal layer 212 prior to compression is preferably not lower than 80%, more preferably not lower than 90%, and particularly preferably not lower than 95%. On the other hand, to ensure good conductivity, the porosity of the porous metal layer 212 prior to compression is preferably not higher than 99.5%, more preferably not higher than 99%, and particularly preferably not higher than 98.5%. The thickness of the porous metal layer 212 prior to assembly of the all-solid-state battery 1 is preferably not smaller than 0.1 mm, more preferably not smaller than 0.3 mm, and particularly preferably not smaller than 0.5 mm; on the other hand, the thickness is preferably not larger than 3 mm, more preferably not larger than 2 mm, and particularly preferably not larger than 1.5 mm. The porous metal layer 212 is preferably a product from Sumitomo Electric Industries, Ltd. (Celmet (registered trademark)), for example. The same applies to the porous metal layer 222, discussed further below.

The electrode layer 22 includes an electrode mixture layer (i.e., anode mixture layer) 221 and a porous metal layer 222. The electrode mixture layer 221 is made of an anode mixture containing an anode active material used in a lithium-ion secondary battery constituted by LTO (Li₄Ti₅O₁₂, i.e., lithium titanate), a sulfide-based solid electrolyte, and graphene in the ratio of 50:40:10 by mass. The porous metal layer 222 is formed by a sheet-shaped porous metal substrate. The electrode layer 22 is an anode pellet obtained by forming the electrode mixture layer 221 and porous metal layer 222 into a columnar shape so as to be stacked upon each other. At this moment, the electrode layer 22 is formed in such a manner that part of the porous metal layer 222 is embedded in the electrode mixture layer 221, more specifically in the surface layer of the electrode mixture layer 211 as shown in FIG. 1 (i.e., the surface layer that faces the porous metal layer 222). Thus, the porous metal layer 222 is formed in such a manner that the active material and/or conductive aid constituting the electrode mixture layer 221 and part of the porous metal substrate have more contact points and, as a result, reduces the internal resistance of the all-solid-state battery 1. Further, to reduce the resistance of the electrode layer 22 present when it contacts the conductive plate 40, the surface of the porous metal substrate may be exposed at the side of the porous metal layer 222 opposite to that adjacent to the electrode mixture layer 221. As shown in FIG. 1, the electrode mixture layer 211 is positioned to face the solid electrolyte layer 23. The porous metal layer 222 is located adjacent to the cap 12, and in contact with the planar bottom portion 42 of the conductive plate 40. As the porous metal layer 222 is positioned between the electrode mixture layer 221 and conductive plate 40, when movement of the power generation element 20 as pressed by the elastic conductive member 30 toward the cap 12 is restrained by the conductive plate 40, the contact resistance will be lower than in arrangements where the surface of the electrode mixture 221 directly contacts the conductive plate 40, thus reducing the internal resistance of the all-solid-state battery 1. Thus, the all-solid-state battery 1 will be able to sufficiently reduce internal resistance and, in addition, sufficiently absorb variations in the thickness of the power generation element 20 or the height of the case 10, for example, thereby reducing variations in internal resistance value. As a result, reliability in electrical connection in the all-solid-state battery 1 will be increased. It will be understood that the anode active material of the electrode mixture layer 221 is not limited to any particular type and is able to function as the anode layer of the power generation element 20, and may be a metallic lithium or a lithium alloy, a carbon material such as graphite or low-crystallinity carbon, or an oxide such as SiO, for example, or may be a predetermined mixture thereof. The other constituent materials and their proportions are not limited to any particular materials/proportions, either. The porous metal layer 222 is identical with the porous metal 212 discussed above. The size and shape of the electrode layer 22 are not limited to a columnar shape, and may be varied depending on the size and shape of the all-solid-state battery 1.

The solid electrolyte layer 23 contains a sulfide-based solid electrolyte. The solid electrolyte layer 23 is columnar in shape. The solid electrolytes contained in the electrode mixture layer 211, electrode mixture layer 221 and solid electrolyte layer 23 are not limited to any particular types; preferable ones include sulfide-based solid electrolytes, especially argyrodite-type sulfide-based solid electrolytes to provide ion conductivity. If sulfide-based solid electrolytes are used, the surface of the cathode active material may be coated with a lithium-ion conductive material such as a niobium oxide to prevent reaction with the cathode active material. The solid electrolytes contained in the solid electrolyte layer 23, electrode mixture layer 211 and electrode mixture layer 221 may be hydride-based solid electrolytes or oxide-based solid electrolytes, for example. The size and shape of the solid electrolyte layer 23 are not limited to a columnar shape, and may be varied depending on the size and shape of the all-solid-state battery 1.

Now, a procedure for fabricating the power generation element 20 will be described. First, solid electrolyte powder is poured into a powder-compacting die with a diameter of 7.45 mm, and a press is used to perform pressure forming at a surface pressure of 70 MPa to form a temporarily formed layer for the solid electrolyte layer 23. Further, an anode mixture as described above is put on the upper surface of the temporarily formed layer for the solid electrolyte layer 23, and pressure forming is performed at a surface pressure of 50 MPa to form a temporarily formed layer for the negative electrode on the temporarily formed layer for the solid electrolyte layer 23. Subsequently, on the temporarily formed layer for the negative electrode formed on the temporarily formed layer for the solid electrolyte layer 23 is laid a cut piece, with a diameter of 7.45 mm, of a foamed metal porous body made of a metal such as nickel, and pressure forming is performed at a surface pressure of 300 MPa to form the solid electrolyte layer 23 and electrode 22 integrated together. Then, the above-mentioned die is vertically inverted; thereafter, a cathode mixture as described above is put on the upper surface of the solid electrolyte layer 23 inside the die (i.e., on the surface thereof opposite to the surface integrated with the electrode 22) and pressure forming is performed at a surface pressure of 50 MPa to form a temporarily formed layer for the positive electrode on the solid electrolyte layer 23. Subsequently, on the temporarily formed layer for the positive electrode formed on the solid electrolyte layer 23 is laid a cut piece of the foamed metal porous body made of a metal such as nickel identical with that used for the negative electrode, and pressure forming is performed at a surface pressure of 1400 MPa to produce a power generation element 20 with an electrode layer 21, a solid electrolyte layer 23 and an electrode layer 22 stacked upon one another and integrated.

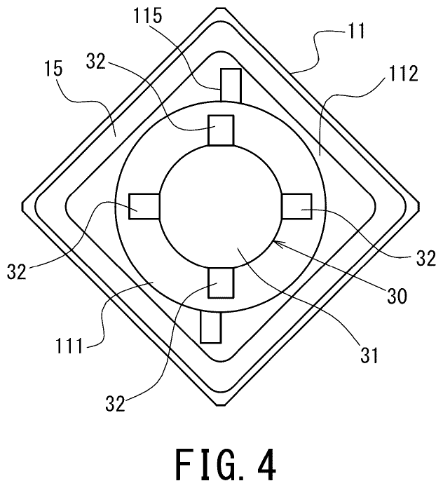

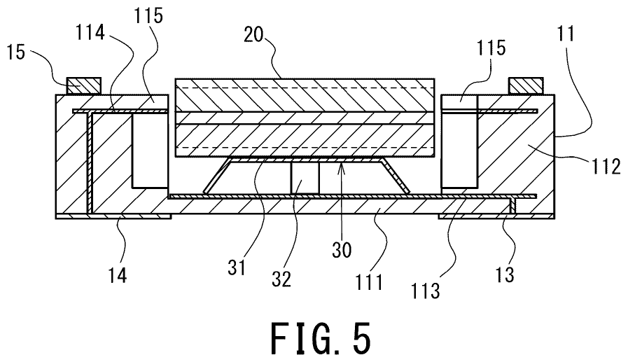

As shown in FIGS. 1 and 4, the elastic conductive member 30 is positioned between the power generation element 20 and the bottom 111 of the recessed container 11. The elastic conductive member 30 is a metallic spring This provides an electrical connection with a lower internal resistance than in arrangements where the elastic conductive member 30 is made of conductive rubber or from carbon sheet, for example. More specifically, the elastic conductive member 30 includes a flat surface 31 and four legs 32. The flat surface 31 is circular in plan view. The flat portion 31 has a surface facing the electrode layer 21 and in contact with the porous metal layer 212. The flat surface 31 uses the elastic force of the elastic conductive member 30 to press the power generation element 20 toward the cap 12. Accordingly, the shape of the flat portion 31 in plan view may be analogous with the shape of the power generation element 20 in plan view. Further, the flat surface 31 is planar in shape so as to be able to press the power generation element 20 toward the cap with a larger area. Thus, as the flat portion 31 presses the power generation element 20 with a larger area, damage to the electrode layer 21 during expansion of the power generation element 20 will be reduced. Further, a good electrical connection will be maintained since a larger contact area is provided between the elastic conductive member 30 and power generation element 20 and the conductive connection between the elastic conductive member 30 and power generation element 20 is made with a larger area. The legs 32 extend from the edge of the flat surface 31 toward the bottom 111 and radially outwardly. FIG. 5 shows how the power generation element 20 and elastic conductive member 30 can be placed in the internal space of the recessed container 11. As shown in FIG. 5, first, the elastic conductive member 30 is laid on the inner bottom surface of the bottom 111 such that the four legs 32 contact the conductor 113, that is, the legs 32 are directed toward the inner bottom surface of the bottom 111 of the recessed container 11 (i.e., directed downward in the drawing). Thereafter, the power generation element 20 is laid on the upper surface of the flat surface 31, with the porous metal layer 212 facing downward, and the power generation element 20 is pushed downward from above. As a result, the power generation element 20 and flat surface 31 move toward the bottom 111 while the four legs 32 expand radially outwardly. Thus, the elastic force of the elastic conductive member 30 presses the power generation element 20 upward. Thereafter, to restrain upward movement of the power generation element 20, the conductive plate 40 discussed further below is positioned above the power generation element 20 and fixed to the side wall 112 of the recessed container 11.

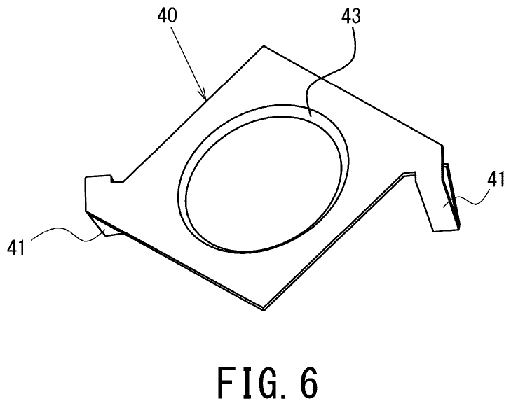

As shown in FIGS. 1 and 6, the conductive plate 40 is a metallic plate that is rectangular in shape in plan view and positioned on the opening of the recessed container 11 of the case 10. The conductive plate 40 includes a plurality of supported portions 41 corresponding in position to the supports 115 described above. According to the present embodiment, the supported portions 41 are hook-shaped locking pieces to be locked to the respective supports 115 described above, that is, to the lower surfaces of the respective ceilings. More specifically, each supported portion 41 extends from an edge of the conductive plate 40 toward the associated support 115 described above (i.e., downward in FIG. 1). The supported portion 41 includes a tip portion sharply bent back toward the lower surface of the associated support 115, i.e., the associated ceiling. The tip of the supported portion 41 is in contact with the conductor 114 exposed at the lower surface and side surface of the ceiling, as discussed above. Thus, the conductive plate 40 functions as a current collector and, at the same time, functions as a connection terminal that electrically connects the electrode layer 22 with the conductive path connected to the external terminal 14. The conductive plate 40 is supported by the supports 115 provided on the inner peripheral surface of the recessed container 11 and covers a portion of the opening of the recessed container 11. The surface area of the conductive plate 40 as measured in plan view is smaller than the area of the opening of the recessed container 11.

The conductive plate 40 has a recessed portion recessed toward the electrode layer 22, located at a position where it contacts the upper surface of the electrode layer 22, which is the other side of the power generation element 20. The planar bottom portion 42 of the recessed portion is planar in shape so as to be able to restrain, with a larger area, movement of the power generation element 20 toward the cap 12 caused by the elastic conductive member 30. Further, the periphery of the recessed portion around the planar bottom portion 42 forms a stepped portion 43 that is displaced as it goes along the thickness direction. The stepped portion 43 is a frustoconical peripheral wall having a diameter gradually decreasing as it. goes toward the power generation element 20. As shown in FIG. 1, the planar bottom portion 42 of the recessed portion has a surface facing the electrode layer 22 and in contact with the upper surface of the porous metal layer 222 in the electrode layer 22. Thus, the flat planar bottom portion 42 contacts the electrode layer 22 with a larger area to restrain movement of the power generation element 20, thereby preventing damage to the electrode layer 22 during expansion of the power generation element 20. Further, a good electrical connection will be maintained since a larger contact area is provided between the conductive plate 40 and power generation element 20 and the conductive connection between the conductive plate 40 and power generation element 20 is made with a larger area. Furthermore, providing the stepped portion 43 will make it possible to reduce the overall thickness of the conductive plate 40. Moreover, the positions of the edges of the conductive plate 40, and thus the supported portions 41, may be freely set along the height direction (i.e., thickness direction of the conductive plate), and thus the distance between the cap 12 and the planar bottom portion 42 of the conductive plate 40 can be prevented from increasing even if a clearance is formed between the cap 12 and the conductive plate 40. This will enable preventing the gap between the cap 12 and power generation element 20 from increasing, thereby increasing the capacity of the all-solid-state battery 1. As used herein, “thickness direction” refers to the top-bottom direction in FIG. 1 (i.e., the height direction of the all-solid-state battery 1), and can also be described as a direction perpendicular to the planar bottom portion 42 in the drawings.

Examples of metals forming the elastic conductive member 30 and conductive plate 40 include nickel, iron, copper, chromium, cobalt, titanium, aluminum, and alloys thereof; to facilitate functioning as a disk spring, stainless steels for springs may be used, such as SUS301-CSP, SUS304-CSP, SUS316-CSP, SUS420J2-CSP, SUS631-CSP and SUS632J1-CSP.

Further, to ensure that the pressing forces of the elastic conductive member 30 and conductive plate 40 against the power generation element 20 are at predetermined levels or higher, each of their thicknesses is preferably not smaller than 0.05 mm, more preferably not smaller than 0.07 mm, and particularly preferably not smaller than 0.1 mm. On the other hand, to avoid an excessively thick conductive plate 40, when placed within the case 10, occupying a large volume therein, and also to facilitate deformation of the conductive plate 40 so it can easily be locked to the side wall 112, the thickness of the conductive plate 40 is preferably not larger than 0.5 mm, more preferably not larger than 0.4 mm, and particularly preferably not. larger than 0.3 mm.

To reduce contact resistance, each of the surface area of the flat portion 31 of the elastic conductive member 30 and the surface area of the planar bottom portion 42 of the conductive plate 40 is preferably not smaller than 10% of the surface area of the associated one of the electrode layers 21 and 22 of the power generation element 20 in plan view, more preferably not smaller than 30%, and particularly preferably not smaller than 50%, and most preferably not smaller than 60%. On the other hand, to reduce the radial gap around the power generation element 20, each of the surface areas of the flat portion 31 and planar bottom portion 42 is preferably not larger than 100% of the surface area of the associated one of the electrode layers 21 and 22 of the power generation element 20 in plan view, more preferably not larger than 95%, particularly preferably not larger than 90%, and most preferably not larger than 86%. Each of the shape of the contact surface of the flat surface 31 with the electrode layer 21 and the shape of the planar bottom portion 42 need not be a completely flat plane, and may be a plane with irregularities, such as an embossed one, to reduce contact resistance with the power generation element 20.

After the elastic conductive member 30 and power generation element 20 are placed in the internal space of the recessed container 11, the conductive plate 40 is laid on the upper surface of the power generation element 20. With the conductive plate 40 laid on the upper surface of the power generation element 20, the tip of each supported portion 41 is positioned between the upper surface of the power generation element 20 and the associated support 115, i.e., the lower surface of the associated ceiling as determined along the thickness direction of the power generation element 20 (i.e., top-bottom direction in FIG. 1). Then, the supported portion 41 of the conductive plate 40 is pushed toward the bottom 111 of the recessed container 11 and, in that state, moved so as to be supported by the support 115. More specifically, the tip of the supported portion 41 is locked to the support 115, i.e., the lower surface of the ceiling. As the supported portions 41 are pushed downward, the conductive plate 40, in contact with the power generation element 20, is deflected in the direction opposite to the direction toward the electrode layer 20. Thus, the conductive plate 40 is able to restrain movement of the power generation element 20 caused by the elastic force of the elastic conductive member 30. Further, the conductive plate 40 is in more stable contact with the power generation element 20, thereby maintaining a good electrical connection without a positional displacement due to vibration, for example. In this instance, forming the aforementioned recessed portion reduces the impact of deflection on the flat planar bottom portion 42, thereby allowing for better maintenance of the electrical connection. Thus, the conductive plate 40 is not limited in its construction as long as it can restrain movement of the power generation element 20 toward the cap 12, with its edges supported on the inner peripheral surface of the side wall 112. Further, although the recessed container 11 includes two supported portions 115, it may include three or more supported portions 115. The number of supported portions 41 may depend on the number of supports 115. Another method of fixing the edges of the conductive plate 40 (i.e., supported portions 41) to the inner peripheral surface of the side wall 112 of the recessed container 11 may be, for example, bonding the edges of the conductive plate 40 to the inner peripheral surface of the side wall 112 of the recessed container 11.

A clearance is provided between the conductive plate 40 and cap 12. In other words, the conductive plate 40 and cap 12 are not in contact with each other. Thus, even when a change in the volume of the power generation element 20 pushes the conductive plate 40 toward the cap 12, the cap 12 will be prevented from deforming. Further, the cap 12 and recessed container 11 are welded together with a seal ring 15 provided therebetween, as discussed above. As a clearance is provided between the conductive plate 40 and cap 12, weld heat will be prevented from affecting the power generation element 20. Furthermore, since the conductive plate 40 and cap 12 are not in contact with each other, the power generation element 20 and/or conductive plate 40 need not be pressed by the cap 12 when the cap 12 is joined to the top end surface of the side wall 112 of the recessed container 11, thereby improving the sealability of the case 10.

Now, Variations 1 and 2 of the elastic conductive member 30 will be described. The same elements as for the elastic conductive member 30 described above will not be described here and, basically, only the elements that represent differences from the elastic conductive member 30 described above will be described.

### Variation 1

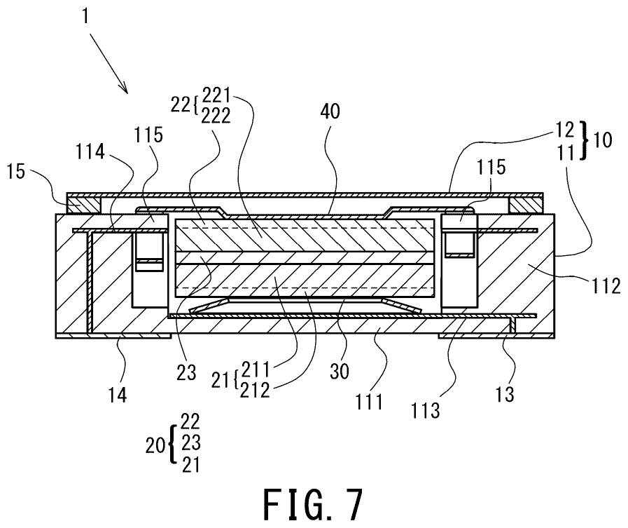

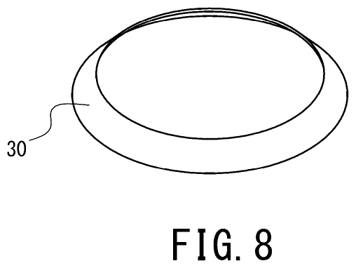

As shown in FIGS. 7 and 8, an elastic conductive member 30 of Variation 1 is a disk spring. The disk spring is made of metal. The disk spring is constituted by a frustoconical peripheral wall with a diameter that gradually decreases. The disk spring has no flat surface 31 as in the above-described embodiment. However, as the upper edge of the disk spring contacts the porous metal layer 212 of the power generation element, the all-solid-state battery 1 will sufficiently reduce internal resistance and, in addition, sufficiently absorb variations in the thickness of the power generation element 20 or the height of the case 10, for example, thereby reducing variations in internal resistance value. As a result, reliability in electrical connection in the all-solid-state battery 10 will be increased. Further, it will enable sufficiently pressing the power generation element 20 toward the cap 12 even if the volume of the internal space of the case 10 that is occupied by the elastic conductive member 30 is reduced. Although FIG. 7 shows that the disk spring is positioned in such a manner that the small-diameter end of the disk spring is in contact with the porous metal layer 212 and the large-diameter end is in contact with the conductor 113, the disk spring may be positioned in such a manner that the large-diameter end of the disk spring is in contact with the porous metal layer 212 and the small-diameter end is in contact with the conductor 113.

### Variation 2

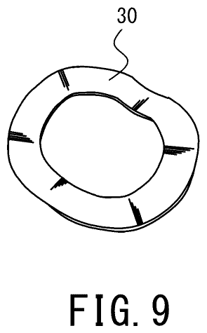

As shown in FIG. 9, an elastic conductive member 30 of Variation 2 is a waved washer. The waved washer is made of metal. The waved washer has no flat surface 31 as in the above-described embodiment. However, as some portions of the upper surface of the waved washer contact the porous metal layer 212 of the power generation element 20, the all-solid-state battery 1 will sufficiently reduce internal resistance and, in addition, sufficiently absorb variations in the thickness of the power generation element 20 or the height of the case 10, for example, thereby reducing variations in internal resistance value. Furthermore, the power generation element 20 or the inner bottom surface of the bottom 11 of the recessed container 11 are in surface contact with the waved washer at a plurality of locations, thereby maintaining a good electrical connection. Moreover, a waved washer has no sharp ends as formed by a part broken off somewhere halfway through it, thereby reducing the risk of damaging the power generation element. As a result, reliability in electrical connection in the all-solid-state battery 1 will be increased.

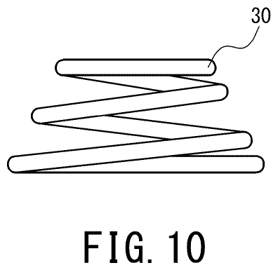

As shown in FIG. 10, an elastic conductive member 30 of Variation 3 is a conical spring. The conical spring is made of metal. The conical spring is in annular contact with the porous metal layer 212 of the power generation element 20. This will produce the same effects as the above-discussed disk spring and, at the same time, enable sufficiently pressing the power generation element 20 toward the cap 12 even if the volume of the internal space of the case 10 that is occupied by the elastic conductive member 30 is even smaller than with the above-discussed disk spring, thereby maintaining a good electrical connection. In implementations where the elastic conductive member 30 is a conical spring, as is the case with a disk spring, the conical spring may be positioned in such a manner that the small diameter end of the conical spring is in contact with the porous metal layer 212 and the large diameter end is in contact with the conductor 113, or the conical spring may be positioned in such a manner that the large diameter end of the conical spring is in contact with the porous metal layer 212 and the small diameter end is in contact with the conductor 113.

Thus, the elastic conductive member 30 used in the all-solid-state battery 1 may be any one of various metal springs that is conductive and is able to press the power generation element 20 toward the cap 12.

In the above-described embodiment, the conductive plate 40 is positioned between the power generation element 20 and cap 12, and the conductive plate 40 and porous metal layer 222 are in contact with each other; alternatively, no conductive plate 40 may be provided and instead a sheet-shaped current collector may be positioned on the lower surface of the cap 12, and the conductor 114 and electrode layer 22 may be electrically connected via the current collector. Yet alternatively, the cap 12 may work as a current collector and the cap 12 may be in contact with the porous metal layer 222. In such implementations, the power generation element 20 pressed by the elastic conductive member 30 toward the cap 12 is restrained by the cap 12 from moving in the cap 12 direction. Thus, the all-solid-state battery 1 does not include a conductive plate 40 if it is able to restrain movement of the power generation element 20 toward the cap 12 and enable electrically connecting the electrode layer 22 with the conductor 114.

In the above-described embodiment, the electrode layer 21 functions as a cathode layer and the electrode layer 22 functions as an anode layer; alternatively, the electrode layer 21 may function as an anode layer and the electrode layer 22 may function as a cathode layer. In such implementations, the external terminal 13 functions as an anode terminal and the external terminal 14 functions as a cathode terminal.

### Second Embodiment

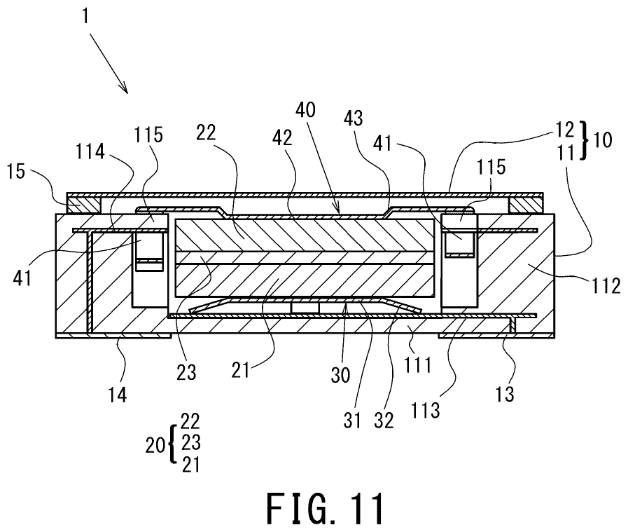

Next, an all-solid-state battery 1 according to a second embodiment will be specifically described with reference to FIG. 11. The same elements as for the first embodiment will not be described here and, basically, only the elements that represent differences from the first embodiment will be described.

In the all-solid-state battery 1 according to the second embodiment, the electrode layers 21 and 22 include no porous metal layers 212 nor 222. Still in some implementations, the electrode layers 21 and 22 may include porous metal layers 212 and 222. That is, whether porous metal layers 212 and 222 are present or not is not relevant in the all-solid-state battery 1 of the second embodiment.

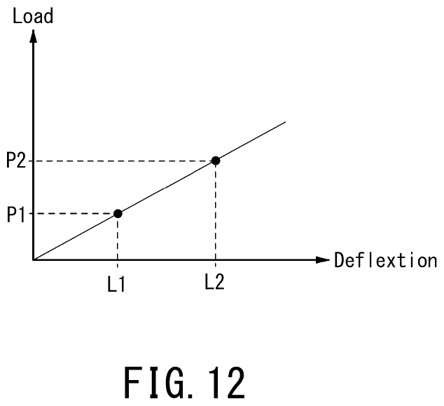

The conductive plate 40 has a load rate higher than the load rate of the elastic conductive member 30. This results in a clearance between the conductive plate 40 and cap 12. This will prevent the cap 12 from deforming due to the pressing by the elastic conductive member 30 or a load from being applied to joints between the recessed container 11 and cap 12 (i.e., seal ring 15). Further, there is no electrical conduction between the cap 12 and power generation element 20, the cap 12 will not have a potential. Load rate may be determined by the difference between the loads at two load points and the difference between the corresponding deflections, as shown in FIG. 12. Specifically, load rate can be expressed by the following expression, (1):

$$load rate = difference in load / difference in deflection = ( P 2 - P 1 ) / ( L 2 - L 1 ) , \qquad ( 1 )$$

where P1 is the load found when the deflection of the elastic conductive member 30 is at L1 and P2 is the load found when the deflection is at L2.

The various variations of the elastic conductive member 30 according to the first embodiment may also be applied to the elastic conductive member according to the second embodiment.

Although embodiments have been described, the present disclosure is not limited to the above-illustrated embodiments, and various modifications are possible without departing from the spirit of the disclosure.

It is also to be noted that the present disclosure will contribute to achieving some of the Sustainable Development Goals (SDGs) set by the United Nations: Goal 7 (ensure access to affordable, reliable, sustainable and modern energy for all); and Goal 12 (ensure sustainable consumption and production patterns).

### REFERENCE SIGNS LIST

1: all-solid-state battery
10: case
11: recessed container
12: cap
13: external terminal
14: external terminal
15: seal ring
111: bottom
112: side wall
113 conductor
114: conductor
115: supports
20: power generation element
30: elastic conductive member
31: flat surface
32: legs
40: conductive plate
41: supported portions
42: planar bottom portion
43: stepped portion

1. An all-solid-state battery comprising:
a case including a recessed container having a bottom and a side wall and a cap covering an opening of the recessed container;
a power generation element sealed in the case and including a first electrode layer located adjacent to the bottom, a second electrode layer located adjacent to the cap and a solid electrolyte layer located between the first electrode layer and the second electrode layer; and
an elastic conductive member located between the power generation element and an inner bottom surface of the bottom of the recessed container,
wherein:
the first electrode layer includes a first electrode mixture layer and a first porous metal layer located between the first electrode mixture layer and the elastic conductive member, and is electrically connected to a first conductive path running from an interior of the case to an outside of the case via the elastic conductive member;
the second electrode layer includes a second electrode mixture layer and a second porous metal layer located between the second electrode mixture layer and the cap, and is electrically connected to a second conductive path running from the interior of the case to the outside of the case;
the first porous metal layer is at least partially embedded in a surface layer of the first electrode mixture layer and integrated with the first electrode mixture layer, and a side of the first porous metal layer opposite to a side adjacent to the first electrode mixture layer is exposed at a surface of the first electrode layer;
the second porous electrode layer is at least partially embedded in a surface layer of the second electrode mixture layer and integrated with the second electrode mixture layer, and a side of the second porous metal layer opposite to a side adjacent to the second electrode mixture layer is exposed at a surface of the second electrode layer; and
the elastic conductive member is adapted to contact the first porous metal layer to press the power generation element toward the cap.

2. The all-solid-state battery according to claim 1, wherein the elastic conductive member is a metal spring.

3. The all-solid-state battery according to claim 1, wherein the elastic conductive member includes a flat surface adapted to contact the first porous metal layer and a leg extending toward the inner bottom surface of the bottom of the recessed container.

4. The all-solid-state battery according to claim 1, wherein the elastic conductive member is a disk spring.

5. The all-solid-state battery according to claim 1, wherein the elastic conductive member is a waved washer.

6. The all-solid-state battery according to claim 1, wherein the elastic conductive member is a conical spring.

7. The all-solid-state battery according to claim 1, wherein:
the all-solid-state battery further includes a conductive plate between the power generation element and the cap;
the conductive plate is adapted to restrain movement, toward the cap, of the power generation element as pressed by the elastic conductive member;
the second electrode layer is electrically connected to the second conductive path via the conductive plate; and
the all-solid-state battery further comprises a clearance between the conductive plate and the cap.

8. An all-solid-state battery comprising:
a case including a recessed container having a bottom and a side wall and a cap covering an opening of the recessed container;
a power generation element sealed in the case and including a first electrode layer located adjacent to the bottom, a second electrode layer located adjacent to the cap and a solid electrolyte layer located between the first electrode layer and the second electrode layer:
an elastic conductive member located between the power generation element and an inner bottom surface of the bottom of the recessed container; and
a conductive plate located between the power generation element and the cap,
wherein:
the first electrode layer is electrically connected to a first conductive path running from an interior of the case to an outside of the case via the elastic conductive member;
the second electrode layer is electrically connected to a second conductive path running from the interior of the case to the outside of the case via the conductive plate;
the elastic conductive member is adapted to contact the first electrode layer to press the power generation element toward the cap;
the conductive plate is adapted to contact the second electrode layer to restrain movement of the power generation element toward the cap; and
a load rate of the conductive plate is higher than a load rate of the elastic conductive member.
